(19) United States
(12) Patent Application Publication
(10) Pub. No.: US 2025/0087108 A1
(43) Pub. Date: Mar. 13, 2025

(54) SYSTEM AND METHOD FOR ENHANCED LEARNING EXPERIENCE WHEN PLAYING MUSICAL INSTRUMENTS

(71) Applicant: BRF Ventures LLC, Burlington, MA (US)

(72) Inventor: Bernardo Faria, Burlington, MA (US)

(21) Appl. No.: 18/243,692

(22) Filed: Sep. 8, 2023

(51) Int. Cl. G09B 15/00; F16M 11/04; F16M 11/14

(52) U.S. Cl. CPC G09B 15/002; F16M 11/041; F16M 11/14

(57) ABSTRACT

A musical instrument accessory for enhancing musical practice and performance is disclosed. The accessory includes a tripod-compatible computing device holder, sized to accommodate and detachably secure the computing device, a first monitor framed within a first protective housing, the first protective housing being pivotally connected to the tripod-compatible computing device holder via a first connector thereby allowing adjustable positioning of the first monitor, and a second monitor framed within a second protective housing, the second protective housing being pivotally connected to the tripod-compatible computing device holder via a second connector thereby allowing adjustable positioning of the second monitor; wherein the first and the second protective housings are connected to opposing sides of the tripod-compatible computing device holder.

### TECHNICAL FIELD

Embodiments disclosed herein relate generally to a system and method for mastering musical instruments and more specifically to holders of computing devices that are utilized while playing musical instruments for enhanced learning experience.

### BACKGROUND ART

The challenge at hand is that beginner guitar players experience discomfort, neck pain, and hindered practice due to the need to constantly shift their focus between the guitar strings, their fingers' position on the chords, and the song's lyrics and chords. This necessitates frequent head rotations, leading to physical strain and reduced practice efficiency.

Existing commercially available tripod mountable holders for computing devices do not adequately cater to the specific needs of musicians during instrument play, leading to discomfort such as neck strains and other unfavorable effects. These holders fail to account for the dual challenge of musicians needing to simultaneously view the computing device's screen and their instrument's strings, resulting in diminished practice experiences.

Consequently, a significant need arises for tripod mountable holders designed exclusively for computing devices, capable of alleviating these challenges by promoting comfortable posture and facilitating efficient viewing of both device screens and instrument strings during musical performances.

### SUMMARY OF THE EMBODIMENTS

To address these issues pertinent to commercially available holders, a novel solution has been devised: a holder for a computing device, such as a smart phone, tablet or the like, which is equipped with two mirrors positioned on each side. This specialized holder is designed to be compatible with a tripod, providing stability and adjustability. By utilizing this holder during practice, beginner guitarists can maintain a leveled head position while playing. The mirrors placed strategically in the holder allow players to effortlessly observe their finger placements on the guitar strings, eliminating the need for excessive head movements. This results in reduced neck pain, enhanced practice experience, and improved progress in learning to play the guitar. The combination of an adaptable tripod and mirrors not only promotes proper posture but also enables players to easily refer to song lyrics and chords on their smartphone screen without the need for constant shifts in attention.

It is worth highlighting that this solution extends beyond guitar players, benefiting a wider community of musicians, including those playing pianos, violins, and other instruments. The tripod compatibility ensures stability and adaptability, while the mirror-enhanced holder promotes efficient practice and enhanced performance.

In summary, the proposed solution, featuring a tripod-compatible computing device holder with dual mirrors, serves as a transformative tool for musicians across different skill levels and instruments. By mitigating discomfort, neck strain, and the need for continuous head rotations, this innovation contributes to more effective practice sessions, increased enjoyment, and overall musical growth.

According to an embodiment of the present invention, a musical instrument accessory for enhancing musical practice and performance is disclosed. The accessory includes a tripod-compatible computing device holder, sized to accommodate and detachably secure the computing device, a first monitor framed within a first protective housing, the first protective housing being pivotally connected to the tripod-compatible computing device holder via a first connector thereby allowing adjustable positioning of the first monitor, and a second monitor framed within a second protective housing, the second protective housing being pivotally connected to the tripod-compatible computing device holder via a second connector thereby allowing adjustable positioning of the second monitor; wherein the first and the second protective housings are connected to opposing sides of the tripod-compatible computing device holder.

Other aspects, embodiments and features of the device and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed device and method, will be better understood when read in conjunction with the attached drawings. It should be understood, however, that neither the device nor the method is limited to the precise arrangements and instrumentalities shown.

FIG. 1A is a front perspective view of a computing device holder with a magnetic plate in accordance with an embodiment of the present disclosure, in horizontal configuration.

FIG. 1B is a front perspective view of a computing device holder with a magnetic plate in accordance with an embodiment of the present disclosure, in vertical configuration.

FIG. 2 is a back perspective view of the computing device holder shown in FIG. 1A.

FIG. 3 is a front perspective view of the computing device holder of FIG. 1A with a computing device mounted thereon.

FIG. 4 is a front perspective view of a computing device holder in accordance with an embodiment of the present disclosure.

FIG. 5 is a front perspective view of a computing device holder having clips in accordance with an embodiment of the present disclosure.

FIG. 6 is a front perspective view of the computing device holder of FIG. 5 mounted on a tripod.

FIG. 7 is a front perspective view of a computing device holder having a mounting member in accordance with an embodiment of the present disclosure.

FIG. 8 is a front perspective view of a computing device holder having a pair of cameras attached thereto in accordance with an embodiment of the present invention.

### DETAILED DESCRIPTION OF SPECIFIC EMBODIMENTS

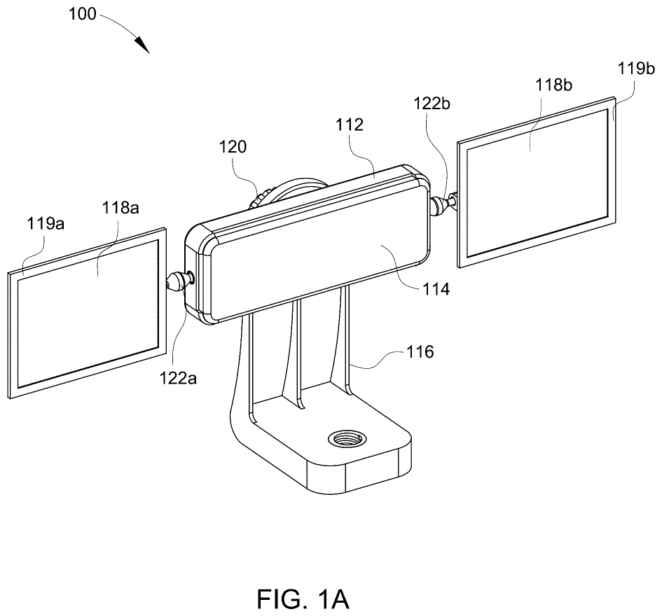

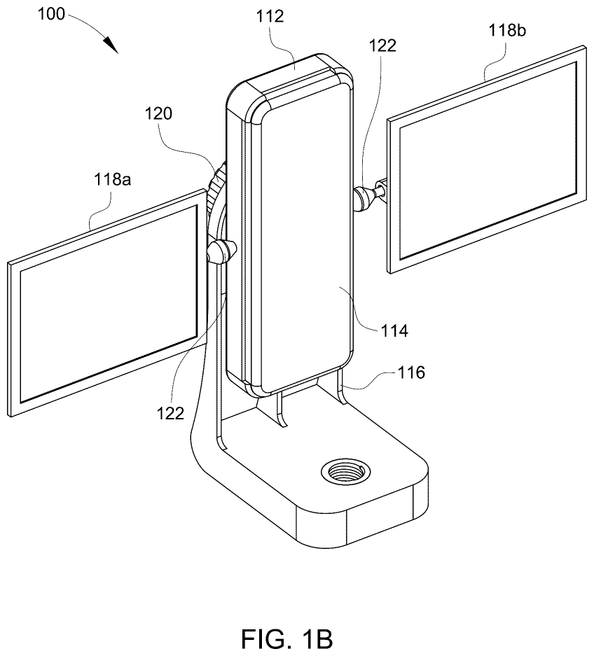

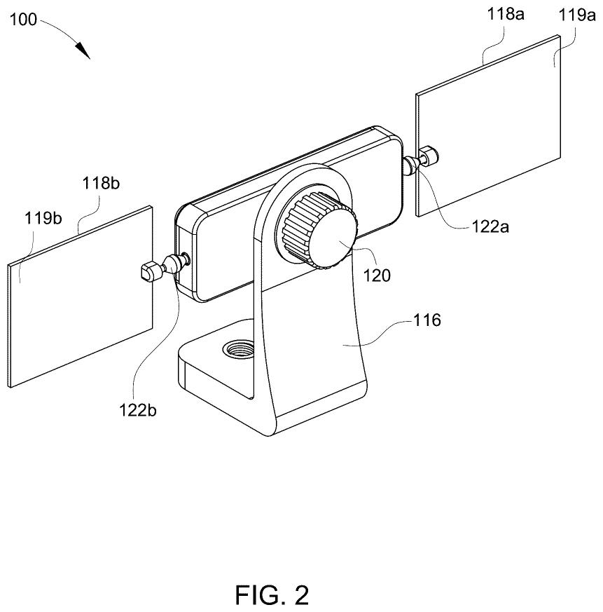

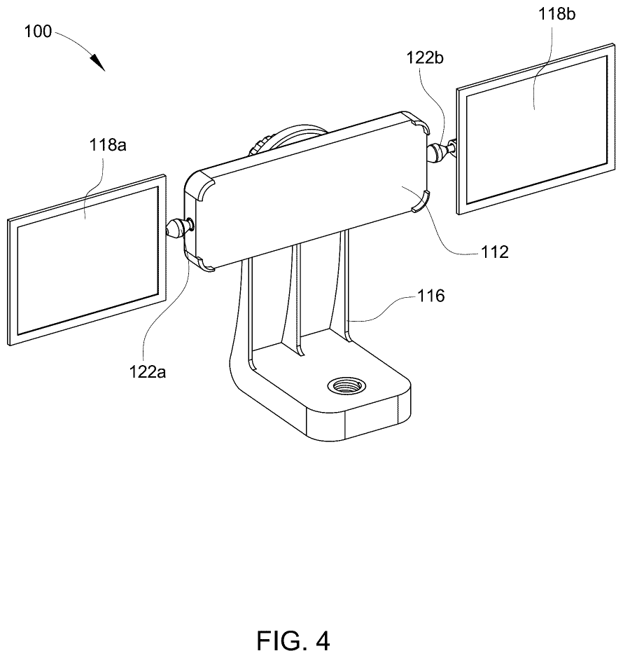

As illustrated in FIG. 1A, the present invention provides a musical instrument accessory 100 for enhancing musical practice and performance, which includes a tripod-compatible computing device holder 112 (as shown in FIG. 4, for example) sized to accommodate and detachably secure the computing device, a first monitor 118a framed within a first protective housing 119a. The first protective housing being pivotally connected to the tripod-compatible computing device holder via a first connector 122a thereby allowing adjustable positioning of the first monitor. The musical instrument accessory 100 also includes a second monitor 118b framed within a second protective housing 119b. The second protective housing being pivotally connected to the tripod-compatible computing device holder via a second connector 122b thereby allowing adjustable positioning of the second monitor. The computing device holder 112 can be pivotally attached to a tripod-mounting member 116 via an angle-adjusting mechanism that includes a screw not shown coupled to a knob 120 as shown in FIG. 2, which allows to place the computing device holder in a horizontal position (as illustrated in FIG. 1A, for example) or vertical position (as illustrated in FIG. 1B) or at any other suitable angle by turning the knob to loosen or tighten the holder's position. In some instances, the holder 112 can be fixedly attached to the tripod-mounting member 116 either in vertical or horizontal position or at a particular angle.

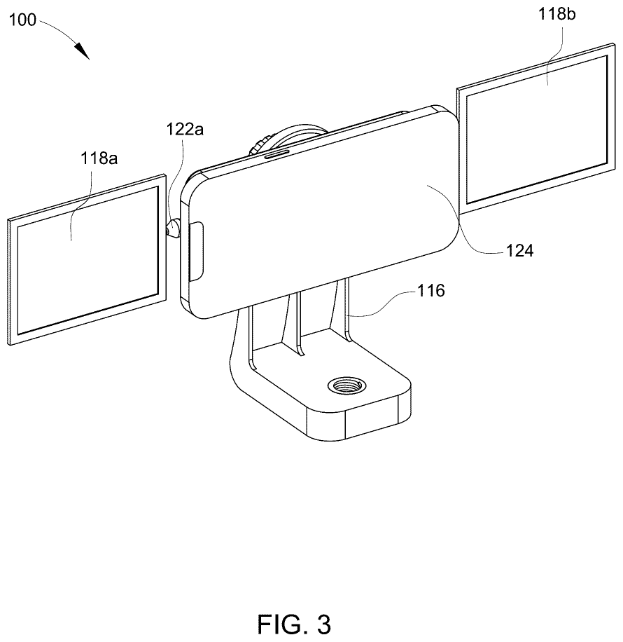

The protective housings 118a and 118b of each monitor can be detachably connected to the computing device holder 112. The detachable connection can be further facilitated by a locking mechanism. The locking mechanism can include a spring-loaded latch, which is being positioned on the tripod-compatible computing device holder to engage with a corresponding receptacle on the protective housing, thereby securing the protective housing in a fixed position. The computing device holder can also include a magnetic base 114 integrated into the holder, as illustrated in FIG. 1A for detachably and securely holding a computing device 124 as further illustrated in FIG. 3. According to some embodiments of the present invention, only one monitor can be employed, monitor 118a or 118b but not both.

The first connector 122a and the second connector 122b can be a ball swivel connector, which provides a high degree of adjustability and freedom in rotation, making them preferable for positioning the monitors in various angles. It will be understood by a person skilled in the art that other types of connectors can be also applicable for achieving the desired adjustable rotation and movement, such as universal joints for adjusting the monitors at different angles while maintaining a stable connection, gimbal joints for smooth, multi-axis rotation of the monitors for an enhanced range of adjustability, spherical hinges that can provide a broad range of rotational movement, pivot joints as well as spherical bearings that can offer multi-axis rotation capabilities, providing the freedom to adjust the mirrors or smart mirrors in different directions. The protective housings of the pair of monitors can be foldable by a virtue of the ball swivel connectors serving as a hinge mechanism, thereby allowing the protective housings to be folded when not in use.

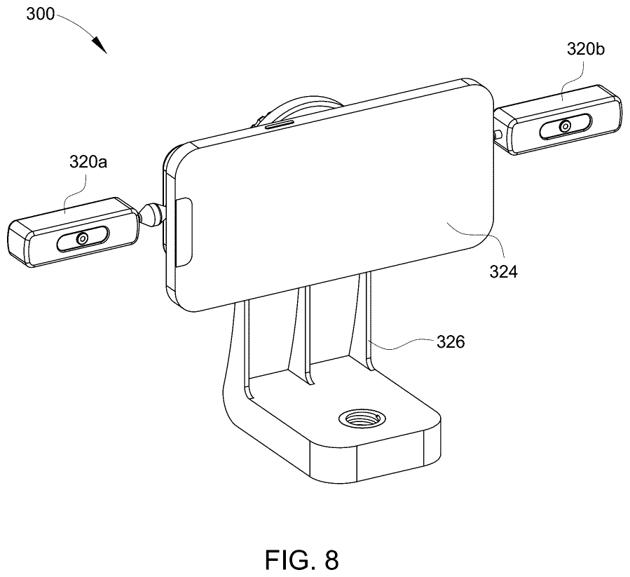

In accordance with the embodiments of the present disclosure, the first monitor and the second monitor can be a mirror. In some instances, the first monitor and the second monitor can be a smart mirror comprising a transparent or semi-transparent digital display positioned behind the reflective surface of the mirror and a touch-sensitive technology overlaid onto the reflective surface or integrated with the digital display. The first monitor and the second monitor can be a video monitor comprising a video display screen capable of presenting visual content. The video monitors can further include a touch-sensitive technology overlaid onto the video display screen. In some instances, the video monitors can further include an integrated camera for capturing images and videos. The video monitors can be a web camera 320a and 320b for capturing video and images, as shown in FIG. 8. In some instances, a combination of different types of monitors can be used. For example, the first monitor can be a mirror and the second monitor can be a smart mirror, or vice versa, or the first monitor can be a video monitor and the second monitor can be a web camera, or vice versa.

According to an embodiment of the present invention, each monitor can be coupled to a computing device wirelessly or through a wired connection. The computing device can be a smart phone, tablet, personal digital assistant (PDA), mini-laptop or any other suitable computing device. It will be appreciated by a person skilled in the art that, according to the present invention, the monitors can come in different shapes such as rectangular, square, oval, circular and more, offering users a wide range of options to suit their preferences and needs.

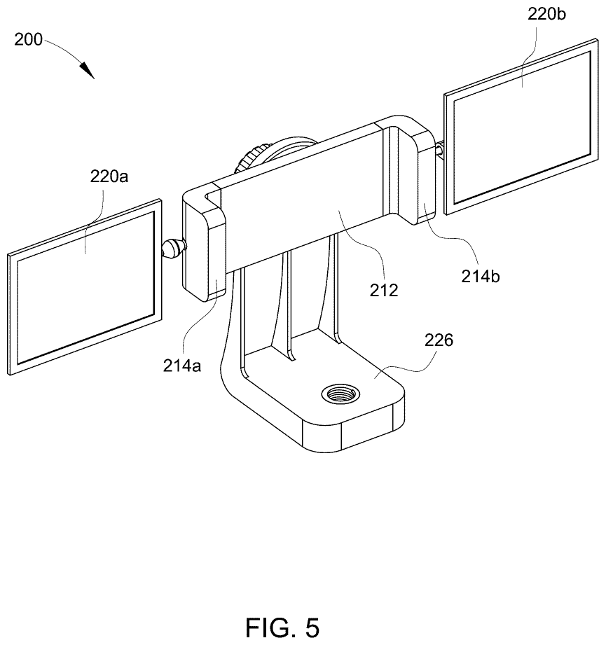

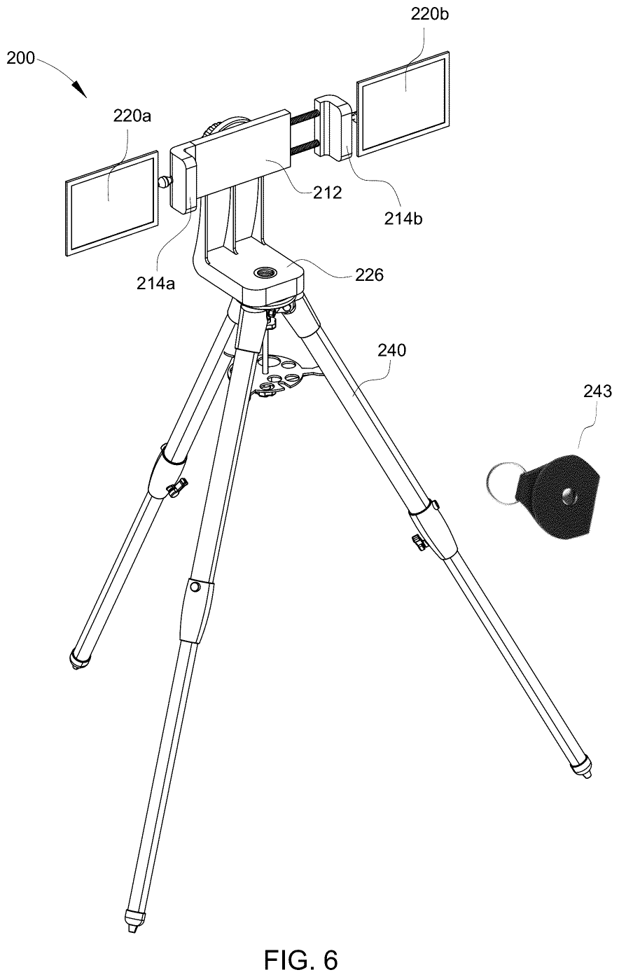

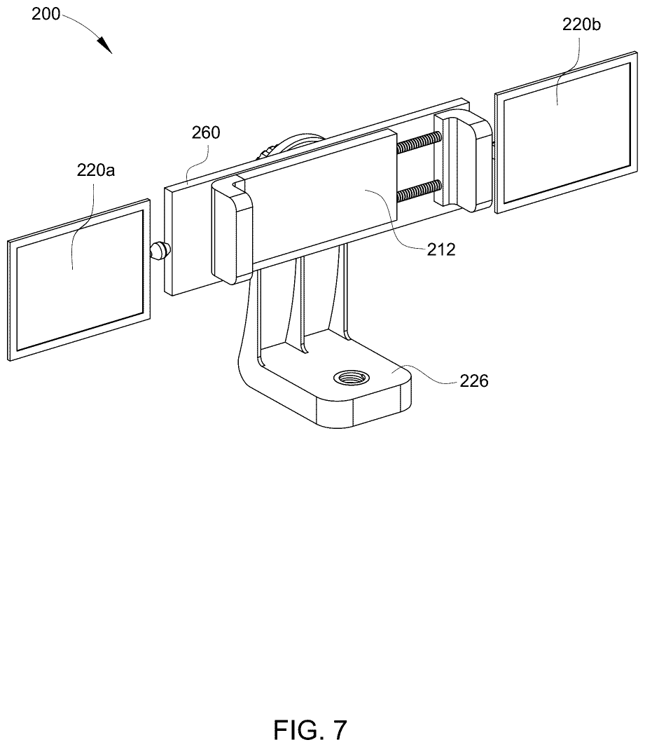

As shown in FIG. 5, the computing device holder 212 can include a pair of spring-loaded clips 214a and 214b respectively, connected to opposing sides of the holder 212 to detachably and securely hold a computing device. In some instances, only one spring-loaded clip connected to one of the opposing sides of the holder. In some instances, the accessory can include a locking mechanism for securing the protective housing in an open position during usage. The monitors 220a and 220b are directly connected to the respective spring-loaded clips 214a and 214b as illustrated in FIGS. 5-6, for example. In some instances, the monitors 220a and 220b can be coupled to the computing device holder 212 via a mounting member 260, as illustrated in FIG. 7, for example.

In accordance with another embodiment of the present disclosure, a system for enhancing musical practice and performance can include the musical instrument accessory as described above and a pocket 243 designed for attachment to a tripod 240 as illustrated in FIG. 6, where the pocket is sized to provide storage and convenient access to one or more musical accessories, such as guitar picks, a tuner, a capo, or combination thereof. The system can further include an adjustable attachment mechanism disposed on the pocket for enabling secure connection to the tripod. The adjustable attachment mechanism can be key chain rings, Velcro straps, buckles, clips and snap hooks, strap and buckle combinations, suction cups, magnetic mounts, strap and Velcro combination and the like. In some instances, the pocket can be attached to the tripod mounting member (116 of FIG. 4). The system can also include a small bar or clip for attaching to a tripod to mount a tuner or capo or any other musical accessories as well as the pocket.

According to the embodiments of the present invention, an AI system for using in conjunction with the musical instrument accessory described above is disclosed. The AI system is configured to perform the following functions. Video Input: Capture video input from the guitar player using a camera or a smartphone. Extract frames or video segments for analysis. Pose Estimation: Apply a pose estimation algorithm to track the guitar player's body and hand positions. Identify key joints and angles, including finger positions and posture. Chord Recognition: Use machine learning models or signal processing techniques to recognize the chords being played based on finger positions. Map the detected finger positions to known chord patterns. Timing Analysis: Analyze the timing of chord changes and strumming patterns. Identify rhythmic patterns and potential timing issues. Performance Evaluation: Compare the detected chord progressions and timing against established patterns and standards. Evaluate the accuracy of chord changes, transitions, and rhythm. Posture Assessment: Analyze the player's posture angles and positions. Detect any deviations from optimal playing posture. Pattern Recognition: Look for common mistakes or challenging segments in chord progressions. Identify instances of incorrect finger placements, missed chords, or awkward transitions. Recommendation Generation: Generate personalized recommendations based on the analysis. Provide suggestions for improving chord changes, finger placements, rhythm, and posture. Feedback Interface: Display real-time feedback on a screen, such as a smartphone or tablet. Show visual cues, graphics, or annotations to highlight areas for improvement. Practice Routines: Suggest practice routines or exercises to address specific challenges. Offer drills to enhance chord transitions, timing, and posture. User Interaction: Allow the player to interact with the AI system, seeking clarification or specific advice. Enable users to request recommendations for particular songs or techniques. Data Logging and Analysis: Log user interactions and practice sessions for further analysis and improvement. Gather data on user progress and effectiveness of recommendations. Adaptation and Learning: Continuously improve the AI model by incorporating user feedback and new data. Refine recommendations based on user ratings and preferences. Deployment: Deploy the AI system as a mobile app or web application for easy access.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. A musical instrument accessory for enhancing musical practice and performance comprising:
a tripod-compatible computing device holder, sized to accommodate and detachably secure the computing device;
a first monitor framed within a first protective housing, the first protective housing being pivotally connected to the tripod-compatible computing device holder via a first connector thereby allowing adjustable positioning of the first monitor; and
a second monitor framed within a second protective housing, the second protective housing being pivotally connected to the tripod-compatible computing device holder via a second connector thereby allowing adjustable positioning of the second monitor; wherein the first and the second protective housings are connected to opposing sides of the tripod-compatible computing device holder.

2. The musical instrument accessory of claim 1, wherein the first connector and the second connector are a ball swivel connector.

3. The musical instrument accessory of claim 1, wherein the first monitor and the second monitor are a mirror.

4. The musical instrument accessory of claim 1, wherein the first monitor and the second monitor are a smart mirror comprising a transparent or semi-transparent digital display positioned behind the reflective surface of the mirror and a touch-sensitive technology overlaid onto the reflective surface or integrated with the digital display.

5. The musical instrument accessory of claim 1, wherein the first monitor and the second monitor are a video monitor comprising a video display screen capable of presenting visual content.

6. The musical instrument accessory of claim 5, wherein the video monitor further comprising a touch-sensitive technology overlaid onto the video display screen.

7. The musical instrument accessory of claim 5, wherein the video monitor further comprising an integrated camera for capturing images and videos.

8. The musical instrument accessory of claim 1, wherein the first monitor and the second monitor are a web camera for capturing video and images.

9. The musical instrument accessory of claim 1, wherein the protective housing of each monitor is detachably connected to the tripod-compatible computing device holder.

10. The musical instrument accessory of claim 9, wherein the detachable connection is facilitated by a locking mechanism.

11. The musical instrument accessory of claim 10, wherein the locking mechanism comprises a spring-loaded latch, the spring-loaded latch being positioned on the tripod-compatible computing device holder to engage with a corresponding receptacle on the protective housing, thereby securing the protective housing in a fixed position.

12. The musical instrument accessory of claim 2, wherein each protective housing of the pair of monitors is foldable by a virtue of the ball swivel connectors serving as a hinge mechanism, thereby allowing the protective housings to be folded when not in use.

13. The musical instrument accessory of claim 1, wherein each monitor is coupled to a computing device wirelessly or through a wired connection.

14. The musical instrument accessory of claim 1, wherein the computing device holder further comprising a magnetic base integrated into the holder.

15. The musical instrument accessory of claim 1, wherein the computing device holder further comprising a pair of spring-loaded clips connected to opposing sides of the holder to detachably and securely hold a computing device.

16. The musical instrument accessory of claim 1, wherein the computing device holder further comprising a spring-loaded clip connected to one of the opposing sides of the holder to detachably and securely hold a computing device.

17. The musical instrument accessory of claim 1, further comprising a locking mechanism for securing the protective housing in an open position during usage.

18. A musical instrument accessory comprising:
a tripod-compatible computing device holder, sized to accommodate and detachably secure the computing device; and a first monitor framed within a first protective housing, the first protective housing being pivotally connected to the tripod-compatible computing device holder via a first connector thereby allowing adjustable positioning of the first monitor.

19. A system for enhancing musical practice and performance, comprising:
the musical instrument accessory of claim 1;
a pocket designed for attachment to a tripod, the pocket is sized to provide storage and convenient access to one or more musical accessories; and
an adjustable attachment mechanism disposed on the pocket, enabling secure connection to a tripod; wherein one or more musical accessories is a guitar pick, tuner, capo, or combination thereof.

20. The system of claim 1, further comprising a tripod attached to the computing device holder by a tripod mounting member.
